(19) United States
(12) Patent Application Publication
(10) Pub. No.: US 2014/0016444 A1
(43) Pub. Date: Jan. 16, 2014

(54) JUMPER, TIMEPIECE MOVEMENT AND TIMEPIECE COMPRISING SUCH A JUMPER

(71) Applicant: PEQUIGNET S.A., Morteau (FR)

(72) Inventors: Huy Van TRAN, La Chaux-de-Fonds (CH); Ludovic PEREZ, Villers-le-Lac (FR)

(73) Assignee: PEQUIGNET S.A., Morteau (FR)

(21) Appl. No.: 14/033,749

(22) Filed: Sep. 23, 2013

Related U.S. Application Data
(63) Continuation of application No. PCT/EP2012/055266, filed on Mar. 23, 2012.

(30) Foreign Application Priority Data
Mar. 23, 2011 (FR) FR1152399

(51) Int. Cl. G04B 11/00

(52) U.S. Cl. CPC G04B 11/008
USPC 368/220

(57) ABSTRACT

A jumper for a timepiece movement is disclosed that includes a base and an elastically deformable arm extending from the base and provided with an abutment surface intended to cooperate with a notch of a mobile. The base may comprise a support element bearing the arm. The base may further comprise two link elements each linking an end of the support element to a fixed element of the base. The jumper may be associated with a control member arranged in such a way that an axial rotation of the control member provokes a displacement of the support element by deformation of a frame, of which the support element and the two link elements form sides.

This application is a continuation application of prior International Application No. PCT/EP2012/055266, filed Mar. 23, 2012, and claiming priority to French (FR) Patent Application No. 1152399, filed Mar. 23, 2011. The disclosures of the above-referenced applications are expressly incorporated herein by reference to their entireties.

### TECHNICAL FIELD

The present disclosure relates to the field of timepieces. More particularly, and without limitation, the present disclosure relates to a jumper for a timepiece movement. The present disclosure also relates to an assembly comprising such a jumper associated with an appropriate control member. The present disclosure also relates to a timepiece movement provided with such a jumper and/or such an assembly. The present disclosure also relates to a timepiece provided with such a movement.

In accordance with certain embodiments, the present disclosure relates to a jumper of an instantaneous or semi-instantaneous or trailing display mechanism. Such embodiments may include an operating reserve indicator or a selected function indicator or a time indication, indicating for example the dates, or the days, or the months, or the hours, or the minutes, or the seconds, or even the phases of the moon.

### BACKGROUND

A jumper is a member of a timepiece movement, which may comprise a base and an elastically deformable arm. The base may be fixed to a frame element of the timepiece movement while the arm extends from the base and may be provided with an abutment surface which may be defined by two inclined facets.

In general, the abutment surface of the arm cooperates with one or more notches of a mobile of the timepiece movement, the mobile being driven by a translational or rotational movement relative to the frame. The action of the abutment surface on the notch(es) makes it possible to temporarily immobilize the mobile in at least one determined position, which confers on the mobile a discontinuous movement, in successive steps.

It may be desirable for each positioning which is immobilized to be stopped with precision. Such is notably the case with a display mechanism through a window, implementing an indicating needle or a window of a dial face. With a window, the indication displayed must be correctly positioned relative to the window, for reasons of both esthetics and reading comfort.

It may sometimes prove necessary to adjust the position of the mobile. For example, in the case of a display mechanism through a window, an adjustment makes it possible to overcome a possibly off-centered display relative to the window, over a long period of use of the timepiece.

The adjustment of the position of the mobile may be obtained by modifying the position of the area of the abutment surface of the arm which acts on the notch(es) of the mobile.

One known adjustment method consists in removing material from said abutment surface, for example by machining. Another known adjustment method consists in fastening the jumper to the frame of the movement by means of an excentric screw, and modifying the angular position thereof in order to displace the abutment surface. Yet another adjustment method consists in bending the arm more or less to displace the abutment surface.

However, the above adjustment methods present a common drawback. In practice, after having removed the movement from the watch case, it is also necessary to remove the dial face, even the display discs, from the timepiece movement, in order to allow access to the abutment surface of the jumper arm or to the excentric screw or to the arm, the access being obtained in a direction substantially perpendicular to the plane of the timepiece movement. The operation of removal of the dial face is time-consuming and sometimes has to be repeated several times to check the accuracy of the adjustment. This removal operation also includes the risk of damaging the components. Finally, when adjustment has been made with a working dial face, it is sometimes necessary to perform a new adjustment with the final dial face.

### SUMMARY

The present disclosure includes embodiments that improve on known techniques and overcome the drawbacks described above. In certain embodiments, a jumper is provided which may comprise an elastically deformable part that makes it possible to modify the position of the abutment surface of the jumper arm relative to the mobile with which it cooperates, this change of position being able to be effected without having to remove the dial face from the movement.

To this end, the present disclosure includes embodiments that provide a jumper for a timepiece movement, which may comprise a base configured to be attached to a frame element of the timepiece movement and from which extends an arm which can be elastically deformed, the arm bearing an abutment surface intended to cooperate with at least one notch of a mobile which may be set in motion relative to the frame element in order to temporarily immobilize the mobile in a determined position.

According to an advantageous feature, the base may comprise a support element which bears the arm, and two link elements which link the support element to a fixed element of the base, the support element, the two link elements and the fixed element form sides of a frame, and the frame can be elastically deformed so as to provoke a displacement of the support element and of the arm that it bears, such that the position of the abutment surface can be adjusted relative to the mobile.

According to another advantageous feature, the frame may behave like an articulated structure having at least four pivot-type articulations.

The present disclosure also relates to an assembly comprising such a jumper associated with a control member, in which the control member may comprise:
a body,
a first head which can be actuated by an operator, and
a thread arranged on an intermediate part of the body, and the control member may be arranged relative to the jumper in such a way that an action of the operator on the first head provokes the displacement of the support element.

In certain embodiments, the support element may have a longitudinal direction and the control member may be arranged in a direction substantially parallel to the longitudinal direction.

According to another feature, the base and the control member may comprise respective guiding elements which may cooperate in such a way that an axial rotation of the control member provokes the displacement, for example a translational displacement, of the support element.

The support element drives with it the arm that it bears. Consequently, the abutment surface of the arm may also be driven in displacement, which modifies its position relative to the mobile with which it cooperates.

Accordingly, the position of the abutment surface of the jumper arm relative to the mobile may be finely adjusted without having to remove the dial face from the timepiece movement, which reduces the duration of the adjustment operation.

Additionally, the base and the control member may comprise respective stabilizing elements which may cooperate to prevent any movement other than an axial rotation of the control member, and of the control elements which cooperate to control the axial rotation of the control member.

According to an embodiment of the present disclosure, the jumper may be a jumper of an instantaneous or semi-instantaneous or trailing display mechanism of a time indication, the display being viewed through a window formed in the dial face of the timepiece.

The present dislosure also relates to a timepiece movement which may comprise a jumper as mentioned above, and/or an assembly comprising such a jumper and a control member, in which the jumper may be arranged to cooperate with a mobile of the timepiece movement.

According to a feature of the timepiece movement, in service, the control member may be arranged between the base and a frame element of the timepiece movement, in such a way that the first head is accessible via the side of the timepiece movement.

Accordingly, it may possible to act on the first head of the control member, from the side of the timepiece movement, to drive the control member in axial rotation.

The present disclosure also relates to a timepiece which may comprise such a movement.

### BRIEF DESCRIPTION OF THE DRAWINGS

Other features and advantages of the present dislosure will become more clearly apparent on reading the following detailed description, given with reference to the appended drawings which are given as nonlimiting examples and in which:

FIG. 1 represents a partial plan view of an exexamplary timepiece movement and shows two jumpers and their associated control members, according embodiments of the present disclosure;

FIG. 2 represents a perspective and plan view of an exemplary jumper, according embodiments of the present disclosure;

FIG. 3 represents a perspective and plan view of an exemplary control member, according embodiments of the present disclosure;

FIG. 4 represents, in partial, perspective and plan view, the base of a jumper and a control member arranged together in a neutral position;

FIG. 5 represents, in plan view, a jumper associated with a control member, in the neutral position of FIG. 4 and in two extreme configurations, the jumper cooperating with a mobile; and

FIG. 6 represents a simplified plan view of the movement of FIG. 1, when it is associated with display members that are visible through a window.

### DETAILED DESCRIPTION OF EMBODIMENTS

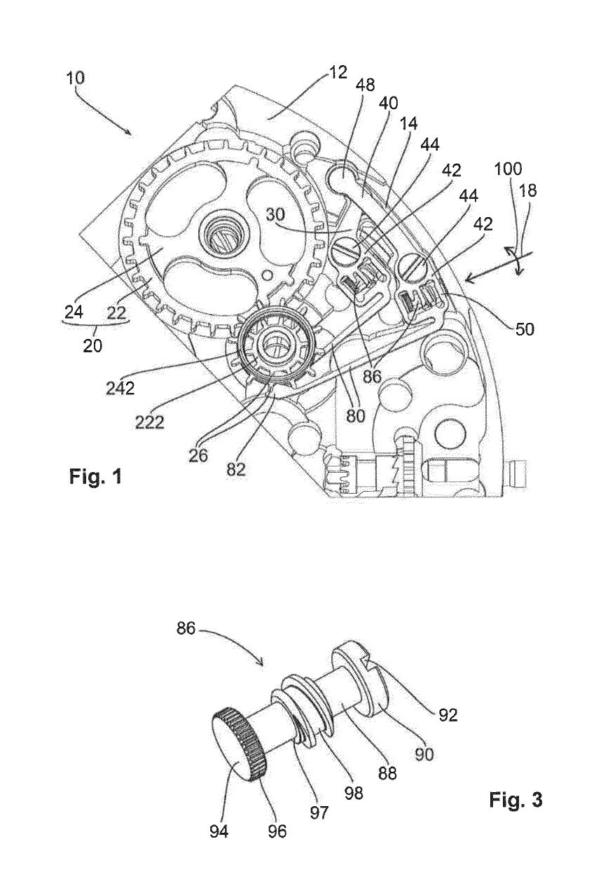

Referring to FIG. 1, a timepiece movement 10 is partially represented that may have a frame element 12, here a plate, intended to house various components, such as, for example, an instantaneous or semi-instantaneous or trailing display mechanism of a time indication.

This display mechanism may comprise a control wheel 20 having two staged sets of teeth 22 and 24 which mesh respectively with two mobiles 222 and 242, both provided with notches. In the example illustrated in FIG. 1, the mobiles 222 and 242 are wheels and the notches are defined between two successive teeth 26 of the respective sets of teeth of the wheels. The mobiles 222, 242 are maintained in determined angular positions, respectively, by jumpers 30 and 40. In the example illustrated, the two jumpers 30, 40 act on two different levels.

The jumpers 30, 40 may be housed in countersinks 14 which are formed in the frame element 12 and which may have appropriate forms. For example, the jumpers 30, 40 may be arranged on the frame element 12 in such a way that they are in proximity to the periphery of the timepiece movement 10.

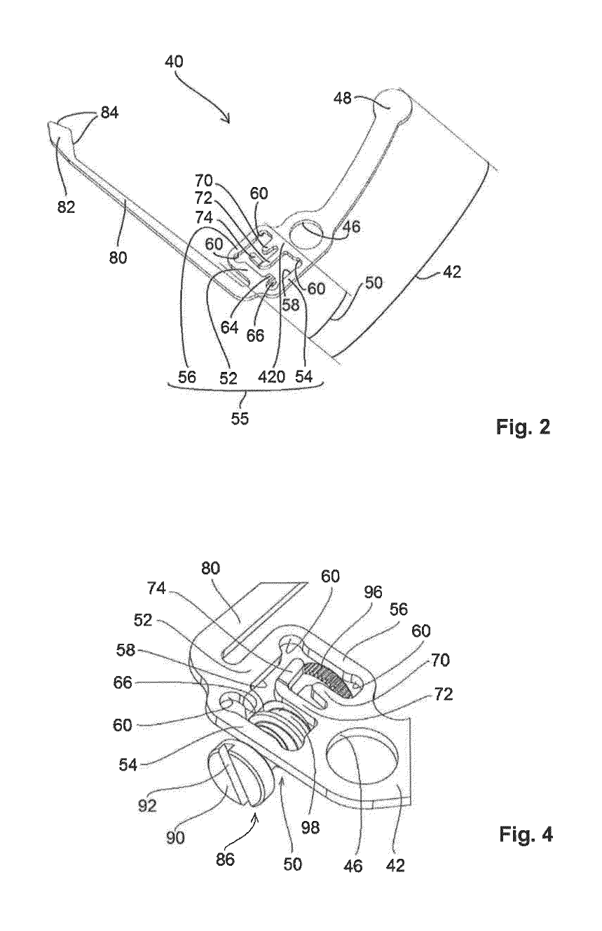

The jumpers 30, 40 may each comprise a base 42 rigidly fastened to the frame element 12 by means of a screw 44 passing through a drill-hole 46 (visible in FIGS. 2 and 4). The base 42 may comprise a protuberance 48 that is offset toward one of its ends, which is housed in a part of the countersink 14 that has a complementary form in order to prevent any rotation of the base 42 parallel to the plane of the frame element 12.

On the other side relative to the screw 44, the base 42 may have an active part 50 which cooperates with a control member 86, as well as an elastically deformable arm 80, generally called spring. The arm 80 may be terminated by an abutment surface 82 which cooperates with the teeth 26 of the corresponding mobile 222, 242.

The jumper 30 may differ from the jumper 40, for example, by the geometry of the base 42 between the drill-hole 46 and the protuberance 48. Since its active part may be similar to that of the jumper 40 and both jumpers 30, 40 have similar operations, the jumper 30 will not be described further, in the interests of simplifying the description and the figures.

The jumper 40 will now be described in more detail, with reference to FIGS. 2, 3 and 4.

FIG. 2 represents exemplary jumper 40 and its arm 80 whose abutment surface 82 has, in the example illustrated, a convex profile delimited by two inclined facets 84.

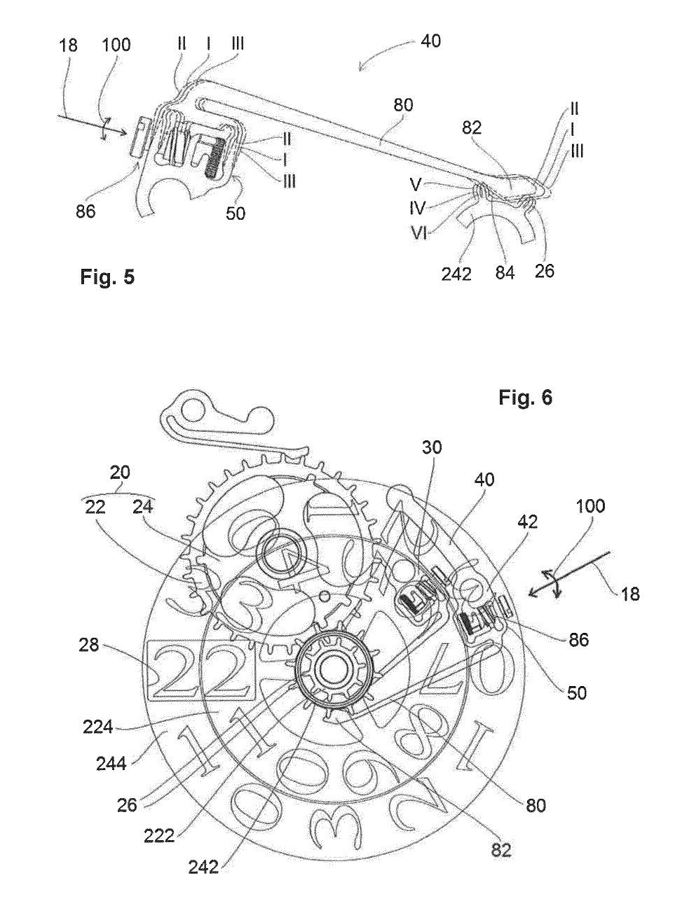

The active part 50 may have an overall planar plate profile. It may comprise a support element 52 which bears the arm 80. In the example illustrated in FIG. 2, the support element 52 may extend in a longitudinal direction which is substantially parallel to the longitudinal direction of said arm 80 when the latter is in the rest position. The active part 50 may also comprise two link elements 54, 56, each of which may link an end of the support element 52 to a fixed element 420 which can be linked to the rest of the base 42 or which may be the rest of the base 42 itself. In the example illustrated, the support element 52 and the two link elements 54, 56 may be substantially rectilinear. They define, with the fixed element 420, a frame 55 that may be at least partially polygonal, following the form of the fixed element 420. In the example illustrated, the fixed element 420 may also be rectilinear, and the frame 55 may have a substantially quadrilateral form, including for example, a rectangular form when it is at rest. The frame 55 extends in the general plane of the active part 50 of the base 42 and delimits therewith an opening 58. The link elements 54, 56 may have a lesser quantity of material at their ends which constitute link areas 60, on the one hand between said link elements 54, 56 and the support element 52 and, on the other hand, between said link elements 54, 56 and the fixed element 420. Consequently, the frame 55 may be elastically deformed in its plane, when it is subjected to the action of a control member, as will be described more specifically with reference to FIG. 5.

The active part 50 may comprise guiding 66, stabilizing 54, 70, 72 and control 74 elements, which extend through the opening 58. They are intended to cooperate with guiding 98, stabilizing 88, 94, 97 and control 96 elements belonging to the control member 86 as will be described with reference to FIGS. 3, 4 and 5.

The active part 50 may comprise a guiding tab 66 which extends toward the frame element 12, in a direction substantially perpendicular to the general plane of the active part 50. The guiding tab 66 may be linked to the support element 52 by means of a separator segment 64 which extends from said support element 52 in a direction substantially perpendicular to the support element 52 and substantially in the general plane of the active part 50. A bend links the guiding tab 66 to the separator segment 64.

A first stabilizing tab 70 and a second stabilizing tab 72 extend through the opening 58, from the fixed element 420, in the general plane of the active part 50 and in a direction substantially perpendicular to the support element 52.

A control pawl 74 extends from the second stabilizing tab 72, in a direction substantially parallel to the support element 52. In the example illustrated, it may be substantially inclined relative to the general plane of the active part 50 while moving away from the frame element 12.

FIG. 3 illustrates exemplary control member 86, which may comprise:
a body 88,
a first head 90 arranged at one end of the body 88,
a second head 94 arranged at the other end of the body 88,
a thread 98 arranged on an intermediate part of the body 88.

In the example illustrated in FIG. 3, the body 88 and the heads 90 and 94 may be cylindrical. The first head 90 may be provided with a slot 92, so as to be able to be used as a screw head whereas the second head 94 may be provided on its periphery with a series of imprints 96, so as to be able to be used as a thumb wheel.

The intermediate part of the body 88 bearing the thread 98 may have a diameter greater than the rest of said body 88 and the thread 98 may be terminated on the side of the second head of 94 by a face 97 substantially perpendicular to the axial direction of the control member 86.

FIGS. 4 and 5 show exemplary jumper 40 on a larger scale in a service configuration, that is to say associated with the control member 86 which may be positioned relative to the base 42.

The control member 86 may be arranged between the active part 50 of the base 42 and the frame element 12 of the timepiece movement 10, facing the opening 58 and in a direction substantially parallel to the longitudinal direction of the support element 52. It may be arranged in a housing formed in the frame element 12 and advantageously having a complementary form. The control member 86 may be arranged in proximity to the periphery of the timepiece movement 10 and oriented in such a way that the first head 90 can be accessed laterally from the outside of the timepiece movement 10 (see FIGS. 1 and 6). Thus, said first head 90 may be actuated by an operator, for example by means of a screw driver which can act on the slot 92 of the first head 90 in the direction embodied by the arrows 18 and 100, as represented in FIGS. 1 and 5.

In the example illustrated in the figures, the control member 86 may be at least partially arranged facing the frame 55.

In service, the guiding tab 66 of the jumper 40 cooperates with the thread 98 of the control member 86. More specifically, it may have a width slightly less than the pitch of the thread 98 and may be engaged therewith. Consequently, when the control member 86 is driven in axial rotation, the guiding tab 66 may be driven in translation in the axial direction of the control member 86.

The respective dimensions of the pitch of the thread 98 and of the guiding tab 66 as well as the length of the thread 98 are determined as a function of the desired linear travel for the guiding tab 66, that is to say as a function of the desired angular travel for the mobile 242 during the adjustment operation.

In service, the control member 86 may be maintained in its housing on the frame element 12 by the stabilizing elements 70, 72, 88, 94, 97. One 54 of the two link elements 54, 56 may be in contact with the body 88, between the thread 98 and the first head 90, and constitutes an additional stabilizing element. The two stabilizing tabs 70, 72 may be in contact with the body 88, between the thread 98 and the second head 94. Also, the two stabilizing tabs 70, 72 act as a spacer arranged between the face 97 of the intermediate part of the body 88 bearing the thread 98 and the face of the second head 94 which is facing said face 97. To this end, the distance between the face 97 and the second head 94 may be determined to be substantially equal to the width of this spacer. As a variant, the spacer could be formed by a single, wider stabilizing tab.

Consequently, the support element 52 may be driven in translation along its longitudinal direction, by deformation of the active part 50 of the base 42, as illustrated in FIG. 5. More specifically, the frame 55 may be deformed without the support element 52 being deformed by deflection. The deformation of the frame 55 may be made possible by the fact that the link areas 60 between the link elements 54, 56 and the support element 52, as well as the link areas 60 between the link elements 54, 56 and the fixed element 420, are weakened. In the example illustrated, the weakening of the link areas 60 evolves from the fact that the vertices of the frame 55 are scalloped.

More generally, the weakening of the link areas 60 may be obtained by a reduction of the section of the link elements 54, 56 toward their ends. Consequently, the frame 55 formed by the four elements 52, 54, 56 and 420 behaves like an articulated structure that has four elements of constant length linked by articulations of pivot type without play. These articulations have a degree of freedom in rotation in the general plane of the active part 50 of the base 42. The maximum amplitude of the displacement of the abutment surface may be determined by the nature of the constituent material of the active part 50, by the length of the link elements 54, 56 and by the degree of weakening chosen at each of their ends. In the example illustrated, the four link areas 60 are weakened in the same way, and the two link elements 54, 56 have the same length, which generates a translational displacement of the support element 52. However, these parameters could be different, which would generate a curvilinear displacement of the support element 52.

When it is displaced in translation, the support element 52 drives with it the arm 80 that it bears. In the example illustrated, the arm 80 may be displaced in translation in the same direction as the support element 52, since they are parallel. Thus, the abutment surface 82 of the arm 80 may be driven by a linear translation.

FIG. 5 also illustrates the adjustment of the angular position of the mobile 242 on which the jumper 40 acts.

Three linear positions of the active part 50 are illustrated: a neutral position I, in which said active part 50 is not deformed, is represented by a continuous line. Two extreme linear positions II and III, respectively on one side and on the other of the neutral position I, are represented by broken lines and correspond to extreme deformations of the active part 50 under the effect of an axial rotation of the control member 86, in one direction or the other, as illustrated by the arrow 100. FIG. 5 shows that the change from the position I to the position II may be obtained by screwing and that the change from the position I to the position III may be obtained by unscrewing, and vice versa.

The three positions I, II, III of the active part 50 correspond to three positions I, II, III of the arm 80 and of its abutment surface 82, of which the two inclined facets 84 cooperate with a notch defined by two consecutive teeth 26 of the mobile 242 which may be then immobilized in a determined angular position.

The three linear positions I, II, III of the arm 80 correspond, respectively, to three angular positions IV, V, VI of the mobile 242, namely a neutral position IV represented by a continuous line, and two extreme positions V, VI represented by broken lines on each side of the neutral position IV.

Furthermore, the axial rotation of the control member 86 may be controlled by means of the control pawl 74, the free end of which cooperates by friction with the imprints 96 of the second head 94, as shown in FIG. 4. More specifically, the second head 94 may act as a thumb wheel which opposes a certain resistance to friction exerted by the control pawl 74. The operator who acts by rotation on the first head 90 in order to rotate the control member 86 thus obtains a feedback that enables him or her to more finely apportion the degree of rotation to be applied to the first head 90. Furthermore, the cooperation of the control pawl 74 with the peripheral imprints 96 of the second head 94 prevents the control member 86 from rotating unnecessarily. Thus, the abutment surface 82 of the arm 80 may occupy a multitude of intermediate discrete linear positions between the two extreme linear positions II and III. Consequently, the mobile 242 may occupy a multitude of intermediate discrete angular positions between the two extreme angular positions V and VI.

In the example illustrated, the arrangement of the control pawl 74 may allow for an advantageously compact design of the active part 50. In practice, it extends from the end of the second stabilizing tab 72, being substantially perpendicular thereto, and toward the first stabilizing tab 70, which may be made shorter than the second stabilizing tab 72. Thus, the control pawl 74 overhangs the first stabilizing tab 70 to reach the periphery of the second head 94 and cooperate with the imprints 96. The inclination of the control pawl 74 relative to the general plane of the active part 50 may be determined as a function of the diameter of the second head 94.

FIG. 6 illustrates two jumpers 30, 40, according to embodiments of the present disclosure, incorporated in a mechanism for displaying the date, of large date type. The latter may comprise a control wheel 20 having a set of teeth for the units 22 and a set of teeth for the tens 24 which respectively mesh with a wheel for the units 222 and a wheel for the tens 242. The latter bear and drive, respectively, a disc for the units 224 and a disc for the tens 244.

A window 28 in the dial face (not represented) shows the date, that is to say a unit indication inscribed on the units disc 224 and a tens indication inscribed on the tens disc 244. In the example illustrated, the date indicated is the 22^{nd} of the current month.

The two jumpers 30 and 40 may cooperate respectively with the teeth 26 of the wheels 222, 242 to ensure their positioning between two instantaneous or semi-instantaneous jumps from one date to the next date. They may each be associated with a control member 86 that conforms to the above description and that can be actuated in rotation (item 100) around its axial direction (item 18), by means of which it may be possible to adjust, respectively, the angular position of the units wheel 222 and the angular position of the tens wheel 242. During the adjustment operation which may be performed from the side of the timepiece movement 10, the dial face may be not removed from said timepiece movement 10. Consequently, the display window 28 remains in place over the displayed time indication, which makes it possible to visually check the accuracy of the adjustment operation at the time when it is carried out.

Embodiments of the present disclosure have been described and illustrated in relation to an example of an instantaneous or semi-instantaneous time indication display mechanism, but embodiments of the present disclosure are not limited as such. For example, embodiments of the present disclosure may apply to any jumper 30, 40 which cooperates with a mobile 222, 242 provided with at least one notch.

Other jumper embodiments could be envisaged without departing from the framework or embodiments of the present disclosure.

For example, the frame 55 of quadrilateral form could be in the form of a parallelogram or trapezium or rhombus or square rather than in the form of a rectangle. The two link elements 54, 56 could, as a variant, be arranged to cross.

The frame 55 could have another polygonal form, with more than four sides. It could have a partially polygonal form, if the fixed element 420 were non-rectilinear.

The deformation of the frame 55 could be obtained by a means other than weakening of the link areas 60 at the ends of the link elements 54, 56, for example by a deformation by deflection of the link elements 54, 56 over a portion of their length.

For example, the control member 86 could be arranged in another way relative to the base 42 of the jumper 30, 40, while providing the same function, that is to say that a rotation of the control member 86 provokes the displacement of the support element 52 and of the arm 80 that it bears. Thus, it would notably be possible to provide for the control member 86 to be arranged in the extension of the support element 52, that is to say outside the frame 55.

Furthermore, the displacement of the support element 52 and of the arm 80 could have a non-rectilinear trajectory, notably if the arm 80 and the support element 52 are not mutually parallel. This displacement could alternatively have a curvilinear trajectory.

According to another alternative, the imprints 96 with which the control pawl 74 cooperates could be formed on a peripheral surface other than that of the second head 94. They could be located on the peripheral surface of the first head 90 or on the peripheral surface of the body 88 of the control member 86, on one side or on the other of the thread 98. The orientation and the inclination of the control pawl 74 would be adapted accordingly.

Moreover, the stabilization of the base 42 relative to the frame element 12 could be obtained by other means. Instead of a protuberance 48 offset toward one end and housed in a portion of countersink of complementary form, the base 42 could be folded and comprise an end part which would extend perpendicularly to the plane of the active part 50. This perpendicular end part could thus cooperate with a complementary blocking piece situated in another plane of the timepiece movement. As a variant, the base 42 could be fastened to and stabilized on the frame element by means of one or more pins.

What is claimed is:

1. A jumper for a timepiece movement, comprising:
a base attached to a frame element of said timepiece movement and from which extends an arm which can be elastically deformed, said arm bearing an abutment surface intended to cooperate with at least one notch of a mobile which can be set in motion relative to said frame element in order to temporarily immobilize said mobile in a determined position,
said base comprising a support element which bears said arm, and two link elements which link said support element to a fixed element of the base,
said support element, said two link elements and said fixed element forming sides of a frame, and
said frame being elastically deformable so as to provoke a displacement of said support element and of said arm that it bears, such that the position of said abutment surface can be adjusted relative to said mobile.

2. The jumper of claim 1, said frame having a form that is at least partially polygonal.

3. The jumper of claim 1, said frame being designed so as to behave like an articulated structure having at least four pivot-type articulations.

4. The jumper of claim 1, said frame being substantially quadrilateral, wherein said link elements can be deformed by flexing at least at their ends which constitute link areas on the one hand between said link elements and said support element and, on the other hand, between said link elements and said fixed element.

5. The jumper of claim 1, said support element having a longitudinal direction, wherein said frame can be deformed so as to provoke a translation of said support element in said longitudinal direction.

6. An assembly comprising:
a jumper for a timepiece movement, the jumper comprising a base attached to a frame element of said timepiece movement and from which extends an arm which can be elastically deformed, said arm bearing an abutment surface intended to cooperate with at least one notch of a mobile which can be set in motion relative to said frame element in order to temporarily immobilize said mobile in a determined position, said base comprising a support element which bears said arm, and two link elements which link said support element to a fixed element of the base, said support element, said two link elements and said fixed element forming sides of a frame, and said frame being elastically deformable so as to provoke a displacement of said support element and of said arm that it bears, such that the position of said abutment surface can be adjusted relative to said mobile; and
a control member comprising:
a body,
a first head which can be actuated by an operator, and
a thread arranged on an intermediate part of said body,
said control member being arranged relative to said jumper in such a way that an action of the operator on said first head provokes a displacement of said support element.

7. The assembly of claim 6, said support element having a longitudinal direction, wherein said control member is arranged in a direction substantially parallel to said longitudinal direction.

8. The assembly of claim 6, wherein said base and said control member comprise respective guiding elements which cooperate in such a way that an axial rotation of said control member provokes a displacement of said support element.

9. The assembly of claim 8, wherein said control member is at least partially arranged facing said frame, wherein said base comprises a guiding tab which extends, in a direction substantially perpendicular to a general plane of said base by being arranged engaged with said thread of said control member.

10. The assembly of claim 6, said base and said control member comprising respective stabilizing elements which cooperate to prevent any movement other than an axial rotation of said control member.

11. The assembly of claim 10, said base comprises a first and a second stabilizing tab extending through an opening defined by said frame, in a direction substantially perpendicular to the longitudinal direction of said support element, and wherein, in service, said stabilizing tabs are in contact with a part of said body of said control member situated between a second head of said control member and said thread thereof, and act also as a spacer between said thread and said second head.

12. The assembly of claim 6, said base and said control member comprising respective control elements which cooperate to control the axial rotation of said control member.

13. The assembly of claim 12, said base comprising a control finger which, in service, cooperates by friction with imprints produced on a peripheral surface of said control member.

14. A timepiece movement including at least one assembly, comprising:
a jumper comprising a base attached to a frame element of said timepiece movement and from which extends an arm which can be elastically deformed, said arm bearing an abutment surface intended to cooperate with at least one notch of a mobile which can be set in motion relative to said frame element in order to temporarily immobilize said mobile in a determined position, said base comprising a support element which bears said arm, and two link elements which link said support element to a fixed element of the base, said support element, said two link elements and said fixed element forming sides of a frame, and said frame being elastically deformable so as to provoke a displacement of said support element and of said arm that it bears, such that the position of said abutment surface can be adjusted relative to said mobile; and
a control member comprising:
a body,
a first head which can be actuated by an operator, and
a thread arranged on an intermediate part of said body,
said control member being arranged relative to said jumper in such a way that an action of the operator on said first head provokes a displacement of said support element, and said jumper being arranged to cooperate with a mobile of said timepiece movement.

15. The timepiece movement of claim 14, in which said control member is arranged between said base and a frame element of said timepiece movement in such a way that its first head is accessible via a side of said timepiece movement.

16. A timepiece comprising at least one timepiece movement including at east one assembly, comprising:
a jumper comprising a base attached to a frame element of said timepiece movement and from which extends an arm which can be elastically deformed, said arm bearing an abutment surface intended to cooperate with at least one notch of a mobile which can be set in motion relative to said frame element in order to temporarily immobilize said mobile in a determined position, wherein said base comprises a support element which bears said arm, and two link elements which link said support element to a fixed element of the base, wherein said support element, said two link elements and said fixed element form sides of a frame, and wherein said frame can be elastically deformed so as to provoke a displacement of said support element and of said arm that it bears, such that the position of said abutment surface can be adjusted relative to said mobile; and
a control member comprising:
a body,
a first head which can be actuated by an operator, and
a thread arranged on an intermediate part of said body,
said control member being arranged relative to said jumper in such a way that an action of the operator on said first head provokes a displacement of said support element, and said jumper being arranged to cooperate with a mobile of said timepiece movement.

17. The jumper of claim 4, said support element having a longitudinal direction, wherein said frame can be deformed so as to provoke a translation of said support element in said longitudinal direction.

18. The assembly of claim 7, said base and said control member comprising respective guiding elements which cooperate in such a way that an axial rotation of said control member provokes a displacement of said support element.

19. The assembly of claim 18, said control member being at least partially arranged facing said frame, wherein said base comprises a guiding tab which extends, in a direction substantially perpendicular to a general plane of said base by being arranged engaged with said thread of said control member.

20. The assembly of claim 7, said base and said control member comprising respective stabilizing elements which cooperate to prevent any movement other than an axial rotation of said control member.
